(19) United States
(12) Patent Application Publication
(10) Pub. No.: US 2026/0160530 A1
(43) Pub. Date: Jun. 11, 2026

(54) Method and technology for both civilian use and military use to subdue aggressive, invasive and harmful AI robot dogs

(71) Applicant: Da LI, Baldwin Park, CA (US)

(72) Inventor: Da LI, Baldwin Park, CA (US)

(21) Appl. No.: 18/972,733

(22) Filed: Dec. 6, 2024

(51) Int. Cl. F41H 13/00; B64D 1/22; B64U 101/16; B64U 101/18; F42B 12/66

(52) U.S. Cl. CPC F41H 13/0006; B64D 1/22; F42B 12/66; B64U 2101/16; B64U 2101/18

(57) ABSTRACT

A method and technique for restraining an aggressive artificial intelligence robot dog, using a drone to deploy a stainless-steel wire ring chain that immobilizes the robot dog upon contact by wrapping around the robot dog's legs and body, and includes a retrieval system for capturing the immobilized robot dog for tactical or security purposes.

### BACKGROUND OF THE PRESENT INVENTION

### Field of Invention

The present invention relates to a method and technique for restraining an aggressive artificial intelligence robot dog, using a drone to deploy a stainless-steel wire ring chain that immobilizes the robot dog upon contact by wrapping around the robot dog's legs and body, and includes a retrieval system for capturing the immobilized robot dog for tactical or security purposes.

### Description of Related Arts

The present invention is both a civilian and military method and technology that can subdue an artificial intelligence robot dog that is aggressive, aggressive, and harmful. There are many types of artificial intelligence robot dogs at present, but it cannot be guaranteed that all artificial intelligence robot dogs will not be aggressive, aggressive, and harmful.

Such cases may happen, one case is that an owner of an artificial intelligence robot dog uses the artificial intelligence robot dog to attack and harm others; second case may happen is that the artificial intelligence robot dog has the functions of machine learning and deep learning, that is, it has the ability to self-learn and continuously improve itself. In the near future, if a certain artificial intelligence robot dog thinks that its intelligence exceeds that of the person who manages it, then the artificial intelligence robot dog will attack humans with bad intentions; third case is that a developer of an artificial intelligence robot dog deliberately sets a malicious program when programming the artificial intelligence robot dog, so that the artificial intelligence robot dog attacks the owner at a certain time point after running for several years. This is very easy to do in automatic control technology, just write some loops and add multiple time relay instructions. Finally, there are military artificial intelligence robot dogs which carry weapons to the battlefield. This method and technology can subdue the artificial intelligence robot dog in the above situation and make the artificial intelligence robot dog lose its ability to move.

### SUMMARY OF THE PRESENT INVENTION

The present invention is both a civilian and military method and technology that can subdue an artificial intelligence robot dog that is aggressive, aggressive, and harmful.

This method uses very thin but strong and elastic stainless steel wire to first form multiple rings, and then form each ring into a long chain, and throw it from the air to the ground to prevent the movement of the artificial intelligence robot dog that walks very fast and very flexibly on the ground in different environments.

### The Composition of This Stainless-Steel Wire Ring Chain

Use type 304 stainless steel wire can choose one kind of wire form 240 SS 0.0240 inch diameter to 0300SS 0.0300 diameter diameter stainless steel wire, because a small difference in diameter will not affect the effect, and weld it into 3-inch, and 5-inch and 15-inch diameter rings by metal shielded arc welding (MIG), tungsten inert gas welding (TIG) and stick welding. Then weld these ring in pairs, three (3-inch diameter) and three (5-inch diameter), three (15-inch diameter) to form a long chain of 8 to 10 stainless steel circles.

Use 3-inch, and 5-inch diameter of type 304 stainless steel wire to form rings mainly used to entangle the legs of an artificial intelligence robot dog, but 15-inch diameter circles of type 304 stainless steel wire to form rings mainly used to entangle the around the body of an artificial intelligence robot dog.

Generally speaking, a long chain of stainless-steel wire rings consists of two large rings with a diameter of 15 inches, three more medium-sized rings with a diameter of 5 inches, and four more small rings with a diameter of 3 inches.

Additional advantages and features of the invention will become apparent from the description which follows, and may be realized by means of the instrumentalities and combinations particular point out in the appended claims.

Still further objects and advantages will become apparent from a consideration of the ensuing description and drawings. These and other objectives, features, and advantages of the present invention will become apparent from the following detailed description, the accompanying drawings, and the appended claims.

### BRIEF DESCRIPTION OF THE DRAWINGS

FIG. 1 is a schematic diagram showing the connection of two rings according to a preferred embodiment of the present invention.

FIG. 2 is a schematic diagram showing a wire ring chain bomb assembly process according to the preferred embodiment of the present invention.

FIG. 3 is a schematic diagram showing the wire ring chain bomb timer start process according to the preferred embodiment of the present invention.

FIG. 4 is a schematic diagram showing the use of the wire ring chain bombs to attack single robot according to the preferred embodiment of the present invention.

FIG. 5 is a schematic diagram showing the use of the wire ring chain bombs to deal with more than ten robot dogs or robot soldiers according to a preferred embodiment of the present invention.

FIG. 6 is a schematic diagram showing the use of the drone to capture the robot dog entangled by the wire ring chain bomb according to a preferred embodiment of the present invention.

### DETAILED DESCRIPTION OF THE PREFERRED EMBODIMENT

The present invention is both a civilian and military method and technology that can subdue an artificial intelligence robot dog that is aggressive, aggressive, and harmful.

This method uses very thin but strong and elastic stainless-steel wire to first form multiple rings, and then form each ring into a long chain, and throw it from the air to the ground to prevent the movement of the artificial intelligence robot dog that walks very fast and very flexibly on the ground in different environments.

### The Composition of This Stainless-Steel Wire Ring Chain

Use type 304 stainless steel wire can choose one kind of wire form 240 SS 0.0240 inch diameter to 0300SS 0.0300 diameter stainless steel wire, because a small difference in diameter will not affect the effect, and weld it into 3-inch, and 5-inch and 15-inch diameter rings by metal shielded arc welding (MIG), tungsten inert gas welding (TIG) and stick welding. Then weld these ring in pairs, three (3-inch diameter) and three (5-inch diameter), three (15-inch diameter) to form a long chain of 8 to 10 stainless steel circles.

Use 3-inch, and 5-inch diameter of type 304 stainless steel wire to form rings mainly used to entangle the legs of an artificial intelligence robot dog, but 15-inch diameter circles of type 304 stainless steel wire to form rings mainly used to entangle the around the body of an artificial intelligence robot dog.

Generally speaking, a long chain of stainless-steel wire rings consists of two large rings with a diameter of 15 inches, three more medium-sized rings with a diameter of 5 inches, and four more small rings with a diameter of 3 inches.

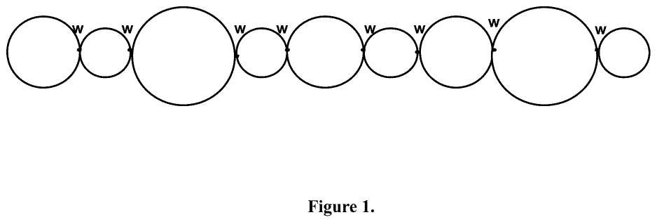

Refer to FIG. 1. The black dot W where the two rings connect is the soldering point.

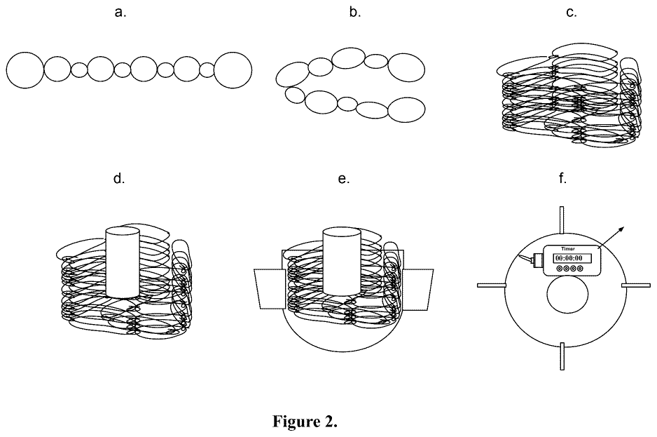

Refer to FIG. 2, the assembly process is illustrated.

### Wire Ring Chain Bomb Assembly With 9 to 12 Stainless Steel Wire Rings Connected.

a. Weld 9 to 12 stainless steel wire rings together in pairs.
b. Bend a set of stainless-steel wire rings chain into a circle with an opening.
c. Bend the stainless-steel wire ring chains into a circle and stack them layer by layer, up to 100 to 200 layers.
d. Insert a hollow paper tube in the middle of the stacked stainless steel wire rings chains.
e. Put them into the paper shell.
f. Install the fireworks explosives in the middle and timer on the top of the paper shell.

### Timer-Started Program

### Stainless Steel Wire Ring Chain Bomb Timer Start Process

State A: When the remote-control unhooking device on the drone has no signal, the toggle switch on the timer on the hook string hanging the stainless-steel wire ring chain bomb is in the OFF state. At this time, the small crank of the two ways toggle switch on the timer forms an angle of about 210 with the string on the small crank, so the string on the small crank will not fall off;
State B: When the remote-control unhooking device on the drone receives the unhooking signal, the hook is released, so the entire stainless steel wire ring chain bomb will fall and pull the string hanging the toggle switch on the timer, and this string will pull the small crank switch of the toggle switch on the timer to the ON state. At this time, the small crank on the timer and the string on the small crank form an angle of about 120, so the string will automatically detach from the small crank switch on the timer. At the same time, the timer starts counting, and the stainless-steel wire ring chain bomb continues to fall with the timer until the count value of the timer is equal to the preset value, and the stainless steel wire ring chain bomb explodes.

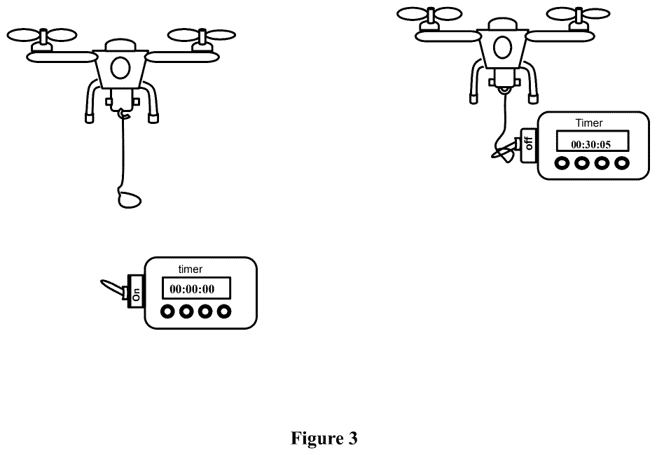

Please refer to FIG. 3.

### Here is a Mode Where a Drone Carries a Stainless-Steel Wire Chain Bomb to Attack a Single Artificial Intelligence Robot Dog

### Two Drones Will Carry Stainless Steel Wire Ring Chain Bombs and Take Turns Attacking the Single Artificial Intelligence Robot Dog

1. The drone needs to hover 3 to 5 meters above the robot dog.
2. After the drone hovers, the remote-control drone thrower releases the stainless-steel wire ring chain bomb hook. The stainless-steel wire ring chain bomb carried by the first drone is designed to make it easy for the artificial intelligence robot dog to be tripped to the ground by a small amount of stainless steel wire rings and chains, causing the artificial intelligence robot dog to move slowly.

Different types of drone airdrop systems or professional release and delivery equipment with remote controls are easy to find on Amazon.
3. The timer of the small bomb starts from this moment.
4. After 2 to 5 seconds, the stainless steel wire ring chain bomb explodes above the artificial intelligence robot dog or about 3 meters from the ground.
5. Throw about one hundred explosive stainless steel ring chains on the ground of 3 to 5 square meters around the artificial intelligence robot dog, so that when the artificial intelligence robot dog moves, one or both feet will be tripped by multiple connected stainless steel wire rings.
6. In this case, the more the artificial intelligence robot dog struggles, the more feet will be tripped by the stainless steel wire ring chain, and even the body of the artificial intelligence robot dog will be caught in the 15-inch large stainless steel wire ring.
7. After the first drone drops the bomb and flies away, the second drone repeats steps 1 to 6 on the artificial intelligence robot dog. The second drone throws nearly one hundred stainless steel wire ring chains, causing the artificial intelligence robot dog, which is already slow in action, to be tripped by more stainless steel wire ring chains and completely lose its ability to move.

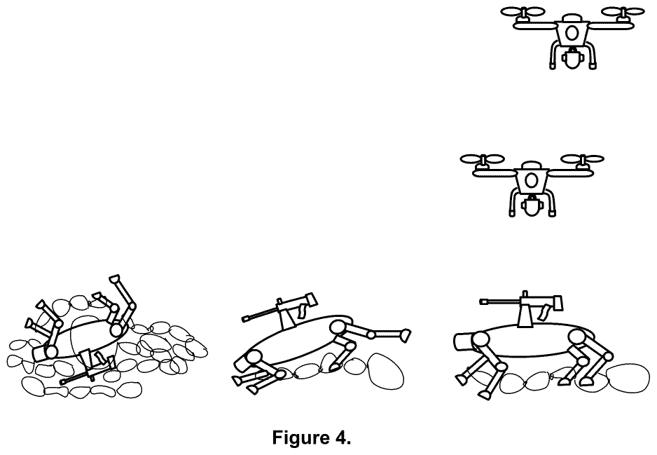

Refer to FIG. 4.

### How to Use Stainless Steel Wire Ring Chain Bombs to Deal With More Than Ten Robot Dogs Or Robot Soldiers?

When the number of artificial intelligence of robot dogs exceeds ten and the number of robot soldiers following the artificial intelligence robot dogs exceeds ten, a swarm of drones carrying stainless steel wire ring chain bombs can be used to launch multiple rounds of attacks on the enemy according to the ground conditions.

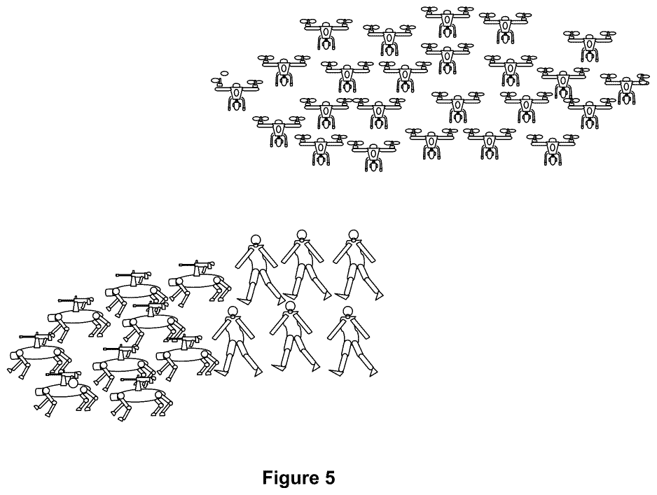

Please refer to FIG. 5.

### The Party Sending Out the Drone can Take the Entangled Robot Dog as a Trophy

When the artificial intelligence robot dog is completely entangled by the stainless steel wire ring and the stainless steel wire chain of the chain bomb dropped by the drone and cannot move, if the drone party is willing to obtain the artificial intelligence robot dog as a trophy, it can send out another drone with a four-claw hook to hook the immobile artificial intelligence robot dog and bring the trophy back.

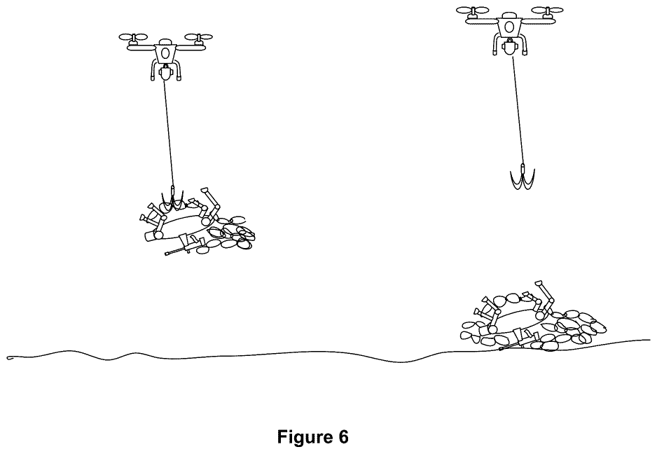

Please refer to FIG. 6.

### SUMMARY

With the development of artificial intelligence robot dogs and artificial intelligence robot soldiers, artificial intelligence robot dogs in some countries have been weaponized and mass-produced. In the civilian field, the following situations may occur:
1. The owner of the artificial intelligence robot dog may use the artificial intelligence robot dog to attack others;
2. Because the artificial intelligence robot dog has the functions of machine learning and deep learning, when an artificial intelligence robot dog thinks that its ability exceeds that of humans, this artificial intelligence robot dog may attack humans;
3. The developers of the artificial intelligence robot dog may program a malicious program that will attack its buyer at a certain time after a few years;
4. In the future, the application of these technologies in weaponized artificial intelligence robot dogs on the battlefield will increase.

In the face of the challenges of these intelligent unmanned technologies, we need to find a simple and low-cost technology to meet these challenges. Because the high-strength stainless steel wire ring chain can withstand bomb explosions, flames, and tanks, we firmly believe that the stainless-steel wire ring chain bomb carried by drones can effectively stop artificial intelligence robot dogs and artificial intelligence robot soldiers on the battlefield.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for fixing an artificial intelligence robot dog by deploying a high-strength stainless steel wire ring, wherein the high-strength stainless steel wire ring interconnects and entangles the legs and body of the robot dog when in contact, rendering it incapable of movement.

2. A method according to claim 1, wherein stainless-steel wires with diameters of 3 inches, 5 inches and 15 inches are first welded into circular rings using metal shielded arc welding, tungsten inert gas welding or welding rod welding, and then the circular rings are welded one by one to form an interconnected chain.

3. A method for making a stainless steel wire ring chain bomb, comprising welding the rings into a chain, stacking them in layers and placing about 100 layers in a paper shell with a hollow tube and a timer in the center, the hollow tube being used to place a fireworks explosives and the top of the fireworks bomb being used to place a timer and a two-way small toggle switch.

4. The method according to claim 3, wherein the timer activated by the two-way toggle handle of the small toggle switch of the timer when the hook is unhooked detonates the stainless steel wire ring chain bomb, and then scatters the stainless steel wire rings around the target area.

5. The method according to claim 1, wherein the drone hovers 3 to 5 meters above the robot dog to ensure the targeted deployment of the ring chain bomb.

6. The method according to claim 1, wherein two drones are deployed alternately to attack a single artificial intelligence robot dog in sequence.

7. The method according to claim 1, wherein multiple rounds of attacks are carried out with swarm drones to subdue more than a dozen artificial intelligence robot dogs or artificial intelligence robot soldiers.

8. The method according to claim 1, wherein a separate drone equipped with a quad-claw hook recovers the fixed artificial intelligence robot dog as a tactical asset.
